(19) United States
(12) Patent Application Publication
(10) Pub. No.: US 2013/0139434 A1
(43) Pub. Date: Jun. 6, 2013

(54) PLANT SUPPORT SYSTEM

(71) Applicants: Catherine CH Warren, East Hampton, NY (US); Alejandro Saralegui, Bridgehampton, NY (US)

(72) Inventors: Catherine CH Warren, East Hampton, NY (US); Alejandro Saralegui, Bridgehampton, NY (US)

(21) Appl. No.: 13/681,070

(22) Filed: Nov. 19, 2012

Related U.S. Application Data
(60) Provisional application No. 61/561,611, filed on Nov. 18, 2011.

(51) Int. Cl. A01G 9/12

(52) U.S. Cl. CPC A01G 9/12
USPC 47/44

(57) ABSTRACT

A novel plant support system having an adjustable frame, one or more stake fasteners for removably coupling the frame to one or more stakes 81 and one or more support members removably coupled to the frame to engage and support one or more plants. The frame includes two slidably interconnected wires capable of adjusting the dimensions of frame, and a plurality stake fasteners capable of adjusting the vertical placement of the frame along one or more stakes. Preferably, the plant support system is a compact, modular system suitable for orienting and maintaining one or more plants in an upright position.

### BACKGROUND OF THE INVENTION

1. Field of the Invention

The present invention pertains to a plant support system. In particular, the invention is directed to adjustable plant support systems capable of accommodating and supporting plants having a wide range of sizes.

2. Description of the Related Technology

Current plant support devices generally have a plant bracing frame anchored to the ground by an integrally coupled stake. Because the adjustment means of these devices can be awkward and difficult to use, and the size of the frame are not easily adjusted. Specialized stakes in many instances are required to enable vertical adjustment of the frames; such frames are therefore incompatible with conventional garden stakes. By virtue of their design, these conventional plant support devices also cannot be used to support large, fully grown plants.

U.S. patent application Ser. No. 12/517,621, for example, teaches a telescoping garden stake having a hollow body for retaining and deploying a plant support hoop. The hoop is constructed from two flexible wires connected by two interlocking hooks. Although the diameter of the hoop may be adjusted by the degree to which the wire is extended from the hollow stake body, no means are provided to stabilize the wires of the hoop or fixedly secure the hoop once a desired dimension is achieved. Furthermore, a telescoping hollow body garden stake is required to deploy, retain and vertically adjust the position of the hoop.

U.S. Pat. No. 5,159,780 discloses a device having a flexible circular collar affixed to a plurality of elongated support members. The diameter of the collar may be adjusted by selectively fastening a plurality of snap button knobs to a plurality of snap button holes arranged along the collar. Similarly, the length of each support member, constructed from two overlapping support components, is adjusted by selectively connecting the snap button holes of an upper support component to the snap button knobs of a lower support component. While the interlocking fasteners may be used to adjust the diameter and height of the circular collar such fastening mechanisms can be time consuming and awkward to use. Furthermore, specialized support members are required to vertically adjust the plant support collar.

U.S. Pat. No. 4,860,489 discloses another plant support device including a longitudinally adjustable cylindrical coil that is coupled to a pair of cylindrical stakes by a plurality of clamps. A hook is formed on each of the clamps to support the cylindrical coil. Such hooks, however, only loosely couple the clamp to the cylindrical coil, undermining the stability and structural integrity of the plant support device as well as inhibiting its load bearing capabilities. Additionally, because the clamps are not integrally coupled to the cylindrical coil, they can be easily separated and misplaced. Furthermore, the diameter of the cylindrical coil appears to be fixed and cannot accommodate the plant as it expands in width.

In view of these deficiencies, there is a need to develop an improved plant support system capable of efficiently adjusting the size and vertical position of a plant supporting frame. There is also a need to develop a durable, load bearing plant support system capable of supporting plants of varying sizes and compatible with a wide range of stakes.

### SUMMARY OF THE INVENTION

In a first aspect, the invention is directed to a plant support system including a frame for surrounding the one or more plants and a fastener for coupling the frame to a stake. The frame includes a first frame member having two wires slidably positioned relative to one another to adjust the frame size, wherein each wire comprises a first end and wherein the first ends of the two wires are interconnected relative to one another such that the first ends slidably overlap one another.

In a second aspect, the invention is directed to a plant support system including a frame for surrounding the one or more plants, wherein the frame includes two interconnected wires slidably coupled relative to one another to adjust the frame size, and two or more pinch clamps permanently and adjustably coupled to the frame, wherein at least one of the wires of the frame is slidably inserted through the pinch clamp.

In a third aspect, the invention is directed to a plant support system including a frame for surrounding the one or more plants, wherein the frame comprises a first frame member comprising two wires slidably coupled relative to one another to adjust the frame size. The system further includes two fasteners capable of being removably coupled to a stake, wherein the two fasteners are permanently and adjustably attached to the frame, and a support member removably attached to and positioned across the frame that braces the one or more plants relative to the frame.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1(a) is a perspective view of a first embodiment of the plant support system.

FIG. 1(b) is a top view of the frame, stake fasteners and support members of FIG. 1(a).

FIG. 1(c) is a top view of the frame, stake fastener and support members of FIG. 1(a) wherein the frame further includes a stabilizer coupled to and supporting the frame member wires.

FIG. 1(d) shows a close-up cross-sectional view of one of the stake fasteners of FIG. 1(a) securing the frame to a stake.

FIG. 1(e) shows a perspective view of the stake fastener of FIG. 1(d) securing the frame to a stake.

FIG. 1(f) shows a perspective view of an alternative stake fastener clamped around a stake.

FIG. 1(g) shows a perspective view of another stake fastener clamped around a stake.

FIG. 1(h) shows a side view of the support member of FIG. 1(a).

FIG. 1(i) shows a side view of an alternative support member.

FIG. 1(j) shows a side view of another support member.

FIG. 2(a) is a perspective view of a second embodiment of the plant support system.

FIG. 2(b) is a top view of the plant support system of FIG. 2(a) showing the frame, stake fasteners, support members and stakes.

FIG. 2(c) is a top view of the plant support system FIG. 2(a) further including two stabilizers, wherein each stabilizer supports and is coupled to the wires of each frame member.

FIG. 2(d) is a top view of multiple plant support systems arranged in a linear row, forming a linear row crop support system.

FIG. 2(e) is a top view of two spaced apart plant support systems connected by a pair of extension members, forming a linear row crop support system.

FIG. 3(a) is a perspective view of a third embodiment of the plant support system.

FIG. 3(b) is a top view of the plant support system FIG. 3(a) further including two stabilizers, wherein each stabilizer supports and is coupled to the wires of each frame member.

FIG. 3(c) is a top view of multiple plant support systems arranged in a linear row, forming a linear row crop support system.

FIG. 3(d) is a top view of two spaced apart plant support systems connected by a pair of extension members, forming a linear row crop support system.

### DETAILED DESCRIPTION OF THE PREFERRED EMBODIMENT(S)

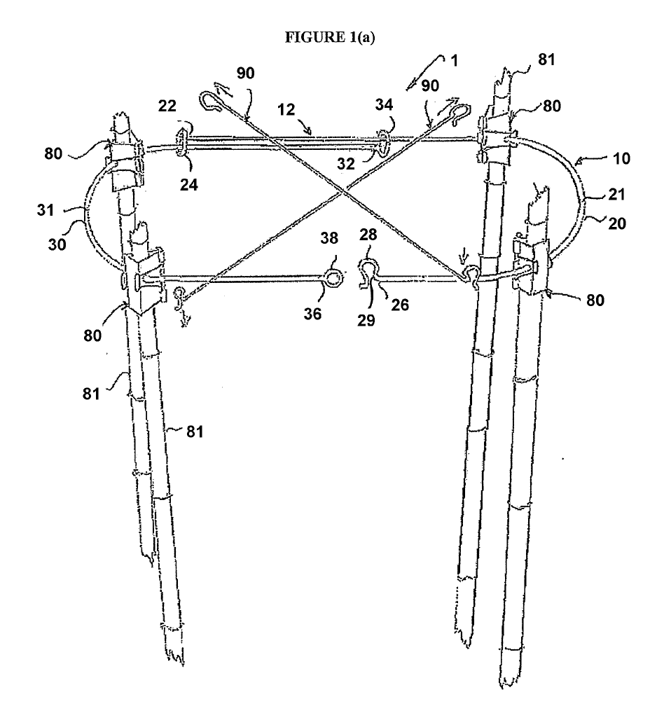

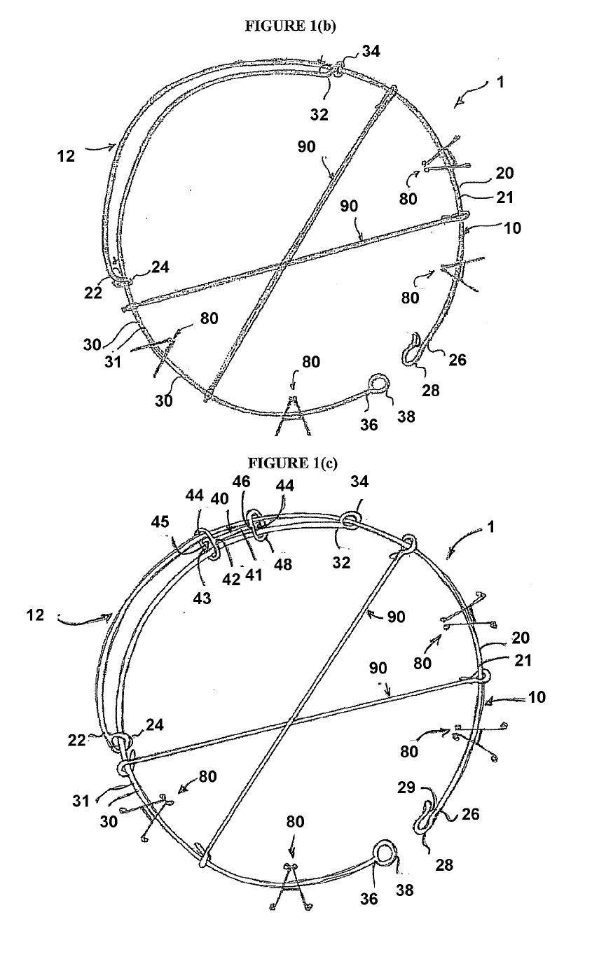

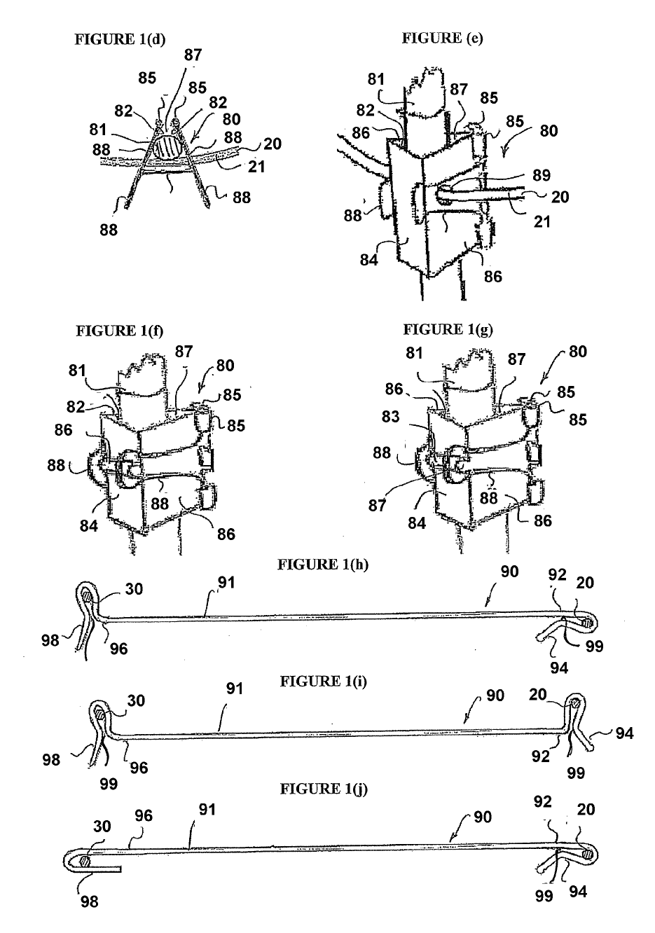

The present invention is directed to a novel plant support system and a method for supporting one or more plants in a desired orientation. The invention is predicated upon the importance of devising a system having: a frame that can be adjustably expanded and retracted to accommodate various sized plants; stake fasteners coupled to the frame that may be removably attached to and vertically adjustable along a stake; and support members removably attached to the frame for structurally supporting a plant. Referring now to the drawings, wherein like reference numerals designate corresponding structures throughout the views, and referring in particular to the exemplary embodiment of FIGS. 1(a)-1(j), plant support system 1 includes one or more frames 10 of adjustable size and one or more stake fasteners 80 adapted for removably coupling frame 10 to one or more stakes 81. Preferably, frame 10 is constructed from two slidably coupled wires 20, 30 capable of adjusting the dimensions of frame 10 and a plurality stake fasteners 80 capable of adjusting the vertical placement of frame 10 along a plurality of stakes 81 detachably coupled to stake fasteners 80. Plant support system 1 further includes one or more support members 90 removably attached to and positioned across frame 10 for engaging and providing support to one or more plants. In an exemplary embodiment, plant support system 1 is a compact, modular system including one or more frames 10 of adjustable size that may be removably attached to and adjustably positioned vertically along one or more stakes 81.

Frame 10 is configured to surround and provide support to one or more plants. By virtue of its adjustable dimensions, frame 10 can accommodate a variety of plants having a wide range of sizes, including but not limited to crop bearing plants, ornamental flowering plants, shrubs and trees, at various stages of development from seedlings to full grown plants. Constructed from one or more frame members 12, each having a first wire 20 adjustably interconnected with a second wire 30, frame 10 may be sizably adjusted as desired to accommodate a plant as it grows and/or is divided. One or more frame members 12 and corresponding wires 20, 30 may be shaped and arranged to form a frame 10 having any suitable shape, size or configuration adapted for surrounding and supporting one or more plants. For example, frame 10 may have a substantially circular, elliptical, rectangular, square, triangular or other desired shape.

In a first embodiment, best shown in FIG. 1(a), frame 10 has a substantially annular configuration formed from a single annular frame member 12. Frame 12 includes two adjustably interconnected semicircular first and second wires 20, 30 that are slidably coupled and adjustable relative to one another. First wire 20 and second wire 30 each have an elongated wire body 21, 31 extending between a first end 22, 32 and a second end 26, 36 thereof.

As shown in FIGS. 1(a)-1(b), first wire first end 22 and second wire first end 32 are slidably interconnected. A wire fastener, such as loop fasteners 24, 34, is formed on each of first ends 22, 32 securing and interlocking first wire 20 to second wire 30. In this interlocking configuration, a portion of first wire 20 proximate to first end 22 is positioned through second wire loop fastener 34 and overlaps with a portion of second wire 30 proximate to first end 33 that is positioned through first wire loop fastener 24. Upon expanding frame 10, first wire first end 22 and loop fastener 24 are drawn towards second wire first end 32 and loop fastener 34. Loop fasteners 24, 34 abut one another thereby interlocking and preventing separation of first and second wires 20, 30 when frame 10 is fully expanded. In instances where an intervening structure, such as stabilizer 40 discussed below, is positioned between first and second wire first ends 22, 32, first and second wire loop fasteners 24, 34 abut the ends of stabilizer 40 when frame 10 is fully extended. When oriented in a retracted or partially retracted orientation, first wire first end 22 and loop fastener 24 are slidably spaced apart from and do not directly engage second wire first end 32 and loop fastener 34. In this position, first wire first end 22 and loop fastener 24 overlap with and/or engage a portion of second wire 30 spaced apart from second wire first end 32 and loop fastener 34. Similarly, second wire first end 32 and loop fastener 34 overlap with and/or engage a portion of first wire 20 spaced apart from first wire first end 22 and loop fastener 24. When stabilizer 40 is positioned between first and second wire first ends 22, 32, at least one of first and second wire loop fasteners 24, 34 is spaced apart from an end of stabilizer 40 when frame 10 is partially or fully refracted.

To achieve the interlocking configuration of first and second wires 20, 30, first wire loop fastener 24 is oriented at an angle with respect to first wire first end 22 so as to extend towards, encircle and receive a portion of second wire 30. Similarly, second wire loop fastener 34 is oriented an angle with respect to second wire first end 32 so as to extend towards, encircle and receive a portion of first wire 20. As shown in FIG. 1(b), first and second wire loop fasteners 24, 34 are oriented at an angle α relative to corresponding first ends 22, 32. Angle α is preferably about 75° to about 105°, more preferably, about 80° to about 100° and most preferably, about 85° to about 95°. In the exemplary embodiment shown in FIG. 1(b), first and second wire loop fasteners 24, 34 are substantially perpendicular with respect to first and second wire first ends 22, 32, respectively and are substantially perpendicular with respect to the longitudinal axis of corresponding wire bodies 21, 31, respectively. Moreover, loop fasteners 24, 34 each have a diameter which prevents fasteners 24, 34 from passing through and detaching from one another. In an exemplary embodiment, loop fasteners 24, 34 may have substantially the same diameter.

As shown in FIGS. 1(a)-1(b), a first mating fastener 28 formed on first wire second end 26 is removably attached to a corresponding second mating fastener 38 formed on second wire second wire second end 36. Upon coupling first and second mating fasteners 28, 38, first and second wires 20, 30 form an enclosed frame member 12 and enclosed frame 10. Exemplary first and second mating fasteners 28, 38 may include interlocking hooks, interlocking clips or corresponding male and female fasteners, such as a male and female quick connect fastener, a latch and corresponding notch or hole, a protrusion and corresponding notch or hole, or a hook and corresponding loop. Preferably, at least one mating fastener has a securing means 29 adapted to secure first mating fastener 28 to second mating fastener 38. In the embodiment of FIG. 1(b), first mating fastener 28 is a hook that folds over a portion of itself forming a C shaped configuration, which may be removably coupled to a loop configured second mating fastener 38. Proximal to the folded end of hook mating fastener 28 is a securing means 29, configured as a narrow, pinched neck structure of hook mating fastener 28 formed by a region of hook mating fastener 28 as it folds over a portion of itself. Hook mating fastener 28 may fold over a portion of itself such that it is proximal to or directly contacts itself, forming an enclosed or substantially enclosed space. Securing means 29 functions to secure and retain a portion of loop configured second mating fastener 38 within the enclosed or substantially enclosed space of hook mating fastener 28. In one embodiment, the opening defined by the pinched neck is substantially equal to or smaller than the diameter of the wire forming second mating fastener 38. Upon inserting an edge of loop mating fastener 38 through the narrow, pinched neck region of hook mating fastener 28, hook mating fastener 28 deflects outwards to receive loop mating fastener 38 and snaps over an edge of loop mating fastener 38, wherein hook mating fastener returns to its original configuration. Hook mating fastener 28 is thus positioned through an aperture of loop mating fastener 28 and retains loop mating fastener 28 within the aperture of hook mating fastener 28. In an alternative embodiment, securing means 29 of hook mating fastener 28 may be configured as a pivoting gate, latch or clasp that forms an enclosed space for locking loop mating fastener 38 therein.

Optionally, one or more stabilizers 40 may be coupled to and support first and second wires 20, 30 such that first ends 22, 32 are substantially aligned with the longitudinal axis of first and second wire bodies 21, 31, respectively. Preferably, first and second wires 20, 30 are positioned in close proximity relative to one another by a stabilizer 40, thereby securing and aligning first and second wires 20, 30 wires in substantially the same plane of orientation. In one embodiment, stabilizer 40 can be configured as a clamp that surrounds and rigidly couples first and second wires 20, 30 such that they form a substantially aligned and continuous rigid structure capable of supporting one or more support members 90. Stabilizer 40 also preferably restricts the movement of first and second wires 20, 30 such that they are substantially limited to a horizontal plane of motion that only permits first and second wires 20, 30 to be horizontally extended and refracted relative to one another.

In the embodiment shown in FIG. 1(c), stabilizer 40 preferably has an elongated wire body 41 having a curved configuration conforming to the curvature of first and second wires 20, 30 and having a passageway 43 for receiving first and second wires 20, 30. Passageway 43 may be formed from one or more openings 45, 47. As shown in FIG. 1(c), opening 45, 47 are defined by two loops 44, 48 positioned on opposite first and second ends 42, 46 of wire body 41. First and second wires 20, 30 are received within, substantially rigidly aligned by and slidably positioned through passageway 43 so as to form a frame 10 having a substantially annular configuration. Stabilizer 40 is coupled to first and second wires 20, 30 such that loops 44, 48 are positioned between first and second first ends 22, 32 and between loop fasteners 24, 34. Loops 44, 48 are preferably sized to tightly receive first and second wires 20, 30 such that the diameter of loops 44, 48 are only slightly larger than the cumulative diameters of first and second wires 20, 30, thereby securely supporting and stabilizing first and second wires 20, 30 relative to one another. In an exemplary embodiment, openings 45, 47 of loops 44, 48 may have a diameter of about 0.16 in to about 0.75 in, preferably, about 0.25 in to about 0.75 in, more preferably, 0.325 in to about 0.75 in, and most preferably, 0.325 in to about 0.5 in.

Stabilizer 40 can be coupled to and adjustably positioned along any overlapping region of first and second wires 20, 30 suitable for supporting, aligning and stabilizing first and second wires 20, 30. Preferably, stabilizer 40 is slidably positioned so that it is situated at a central region between first ends 22, 32. Alternatively, stabilizer 40 can be positioned proximate to one of first and second wire second ends 26, 36. In one embodiment frame 10 may include two or more slidably positioned stabilizers 40 as necessary to support, align and stabilize first and second wires 20, 30 relative to one another. For example, a first stabilizer 40 may be positioned proximate to first wire first end 22. A second stabilizer 40 may be positioned proximate to second wire first end 32, and a third stabilizer 40 may be positioned between first and second stabilizers 40.

In the embodiment shown in FIGS. 1(a)-1(j), frame 10 may be retracted and expanded such that first and second wires 20, 30 completely overlap, partially overlap or are only connected at first and second wire first ends 22, 32 and second ends 26, 36. In one embodiment, each of first and second members 20, 30 may have a length of about 11 in to about 33 in, preferably, about 16 in to about 28 in, more preferably, about 20 in to about 28 in, and most preferably, about 20 in to about 25 in. Frame member 10, having a circular configuration, may have a diameter of about 7 in to about 21 in, preferably, about 10 in to about 18 in, more preferably, about 13 in to about 18 in and most preferably, about 13 in to about 16 in.

Frame 10, including one or more frame members 12, first wire 20 and second wire 30, as well as optional stabilizer 40 may be constructed from any suitable material adapted to maintain the structural integrity of the frame, provide a sufficient rigidity and enable load bearing capabilities necessary to support one or more plants. Exemplary materials may include metals, plastics or combinations thereof. Preferably, Frame 10 and stabilizer 40 may be constructed from a memory metal capable of assuming a preformed configuration even after repeated deformation. In an exemplary embodiment, the wires used to construct frame members 12 may have a wire gauge of about 1 gauge to about 23 gauge, preferably, about 8 gauge to about 12 gauge, more preferably, about 9 gauge to about 11 gauge and most preferably, 10 gauge to about 11 gauge.

As best shown in FIGS. 1(a)-1(g), one or more stake fasteners 80 coupled to frame 10 are adapted to removably receive one or more stakes 81. Preferably, two or more, four or more, six or more or eight or more stake fasteners 80 may be attached to frame 10. Stake fasteners 80 are permanently secured to and adjustably arranged along frame 10, allowing stake fasteners 80 to be slidably positioned along the frame 10 so as to be aligned with the position of stakes 81. Preferably, stake fasteners 80 are arranged along frame 10 so as to stably support and equally distribute the weight of frame 10 and the supported plant to stakes 81. Upon coupling stake fasteners 80 to stakes 81 anchored in the ground, the size and dimensions of frame 10 become fixed. Stake fasteners 80 and stakes 81 therefore operate as a locking mechanism for fixedly securing first wire 20 relative to second wire 30 and fixedly positioning frame 10 in a specific configuration. Upon detaching stake fasteners 80 from stake 81, it is possible to readjust the size and configuration of frame 10. Additionally, upon detaching stake fasteners 80 from stake 81, it is possible to vertically repositioning frame 10 relative to stake 81 and adjust the height of frame 10 as desired.

As shown in FIG. 1(a), four stake fasteners 80 are substantially equidistantly positioned along frame 10, wherein first and second wire 20, 30 each have two symmetrically positioned stake fasteners 80. Stake fasteners 80 are slidably positioned along first and second wires 20, 30 of frame member 12 between first ends 22, 32 and second ends 26, 36. A wire 20, 30 passes through and is slidably coupled to the body of each stake fastener 80, allowing stake fastener 80 to be adjustably positioned along first and second wires 20, 30 and thereby accommodating frame 10 as it is expanded and retracted. By permanently securing stake fasteners 80 to first and second wires 20, 30, this interconnected system prevents the inadvertent separation and misplacement of stake fasteners 80 when not in use. Additionally, this integral assembly of stake fasteners 80 and frame 10 forms a compact system that is easily stored and assembled.

Stake fastener 80 may have any suitable configuration adapted for removably securing a stake 81 and for adjustably positioning stake fastener 80 vertically along a stake 81. Preferably, stake fastener 80 is configured as a clamp to facilitate and enable quick attachment and detachment from stakes 81.

In the exemplary embodiment shown in FIGS. 1(d)-1(e), stake fastener 80 is configured as a metal pinch clamp having a substantially triangular body formed from a base 84 connected to two opposing compression spring side walls 86 that are inclined and biased towards one another. A first end of each of the side walls 86 integrally formed with base 84 while an opposite second end 85 of each side walls 86 is spring biased towards one another such that the second ends 85 of side wall 86 are compressed against one another. Handles 88 attached to each side walls 86, preferably attached to second end 85, is used to force apart second ends 85 upon compressing the handles 88 towards one another. When opened, a stake 81 may be inserted within an internal cavity 87 of stake fastener 81. The inner surfaces 82 of side walls 86 frictionally engage and clamp around stake 81 to secure stake 81 within internal cavity 87. Side wall inner surfaces 82 may be contoured and adapted to be fixedly secured to any conventional stake 81, such as a bamboo rod, metal rod, or plastic rod. In the embodiment of FIGS. 1(d)-1(e), side wall inner surface 82 may have a substantially planar configuration. Alternatively, side wall inner surfaces 82 may have a curved configuration conforming to the circumference of stake 81.

As shown in FIGS. 1(d)-1(e), a hole 89 is positioned through each of the side walls 86 to receive and allow passage of a wire 20 or 30 through the body of stake fastener 80. Holes 89 are preferably formed proximal to base 84, such that a wire 20 or 30 positioned through the holes 89 of side walls 86 is located proximal to base 84 and does not substantially interfere with a stake 81 positioned within internal cavity 87. By virtue of positioning holes 89 through side walls 86, a wire 20 or 30 is securely retained within and is able to structurally supported by stake fastener 80. As shown, holes 89 may be positioned between the frame of handles 88. Alternatively, holes 89 may be positioned above or below the frame of handle 88 as desired.

In alternative embodiments shown in FIGS. 1(f)-1(g), stake fastener 80 may have a similar configuration as that of FIGS. 1(d)-1(e) with the exception that base 84 has a protrusion 83 for coupling frame 10 to stake fastener 80. This protrusion 83 replaces the need for holes 89 and forms an elongated channel that conforms to and is adapted to receive wire 20 or 30. In an exemplary embodiment, protrusion 83 may have a cylindrical, semi-cylindrical or rectangular configuration. Its elongated channel may be separated from internal cavity 87 by base 84, as shown in FIG. 1(f), or connected to internal cavity 87, as shown in FIG. 1(g). Inlet and outlet openings are spaced apart from one another and positioned on opposite ends of protrusion 83 for receiving a wire 20 or 30. The protrusion 83 can span across a portion of base 84, including an area less than or substantially equal to the entire width of base 84. By virtue of positioning a wire 20, 30 within the elongated channel formed by protrusion 83, more space within internal cavity 87 may be made available to receive stake 81.

Plant support system 1 may further operationally include one or more support members 90 that are removably coupled to and positioned across a portion of frame 10 for engaging and providing structural support to one or more plants, as shown in FIGS. 1(a)-1(c). Support members 90 may be coupled to frame 10 in any desired arrangement. For example, support members 90 may positioned across the center or a periphery of frame 10. Two or more support members 90 may be positioned parallel to or may crossover one another. Preferably, two or more support members 90 intersect one another as they extend across frame 10 and engage different portions of frame 10. In one embodiment, at least two support members 90 may be perpendicularly oriented with respect to one another. For example, support members 90 may form a series of overlapping rows and columns. The plant is ideally centrally positioned within frame 10 and braced by support members 90 and frame 10 such that it is maintained in a substantially upright position.

Support member 90 may be any device capable of being removably positioned across and coupled to frame 10 so as to support one or more plants. Exemplary support members 90 may include bars, rods or other rigid scaffold structures for providing load bearing support to a plant. Preferably, support member 90 has a substantially rigid body of sufficient load bearing capabilities and tensile strength for applying a force to a portion of a plant in order to restrain, adjust the position of or correct the alignment of a plant. Support member 90 can be constructed from any suitable material, including metals or plastics.

In the exemplary embodiment shown in FIG. 1(h), support member 90 is a thin, rigid wire rod having an elongated body 91 that has a sufficient tensile strength to correct the alignment of a plant. Additionally, wire body 91 is sufficiently flexible so as to enable one or more support members 90 to be positioned over or under one or more other support members 90. Preferably, support member 90 may be constructed from wire having a wire gauge of about 11 gauge to about 23 gauge, preferably 11 gauge to about 14 gauge and most preferably, about 12 gauge to about 14 gauge.

A hook 94, 98 is formed on each opposing end 92, 96 of wire body 91. First and second hooks 94, 98 are formed by distal ends of wire body 91 folding over a portion of itself so as to form a hook and an enclosed or substantially enclosed space. Preferably, hooks 94, 98 include a narrow, pinched neck region 99 that secures and retains a portion of frame 10 within the enclosed or substantially enclosed space of hooks 94, 98. In one embodiment, an opening defined by the pinched neck region 99 is substantially equal to or smaller than the diameter of a first or second wire 20, 30 of frame 10. Upon inserting a section of first or second wires 20, 30 through this narrow, pinched neck region 99, hooks 94 or 98 deflects outwards to receive first or second wires 20, 30 and subsequently snaps over an edge thereof, returning to its original configuration. First or second wire 20, 30 is thus positioned through and retained within an aperture of hook 94, 98. In the embodiment shown in FIG. 1(h), first hook 94 is substantially perpendicular to of first end 92 and the longitudinal axis of wire body 91 while second hook 98 is substantially parallel to the second end 96 and the longitudinal axis of wire body 91. Alternatively, first and second hooks, 94, 98 may be substantially perpendicular to first and second ends 92, 96 and the longitudinal axis of wire body 91, as shown in FIG. 1(i), or substantially parallel to first and second ends 92, 96 and the longitudinal axis of wire body 91, as shown in FIG. 1(j). In the embodiment of FIG. 1(j), preferably at least one hook does not have a pinched neck to facilitate detachment.

Support member 90 may have any suitable length for spanning one or more regions of frame 10. In an exemplary embodiment, support member 90 may have a length of about 7 in to about 21 in, preferably, about 10 in to about 18 in, more preferably, about 13 in to about 18 in and most preferably, about 13 in to about 16 in. Preferably support member 90 have a length substantially equal to the diameter of frame 10. In one embodiment, plant support system 1 may include a plurality of support members 90 having different lengths to accommodate the adjustable size of frame 10. For example, one or more support members 90 may have a length of about 7 in to about 13 in, more preferably, about 7 in to about 10 in or about 10 in to about 13 in. Another support member 90 may have a length of about 10 in to about 16 in, preferably, about 13 in to about 16 in. A third support member may have a length of about 15 in to about 21 in, preferably, about 15 in to about 18 in or about 18 in to about 21 in. In another example, plant support system 1 may include a plurality support members 90 having a length equal to about the diameter of frame 10, about ¾ the diameter of frame 10 and about ½ the diameter of frame 10.

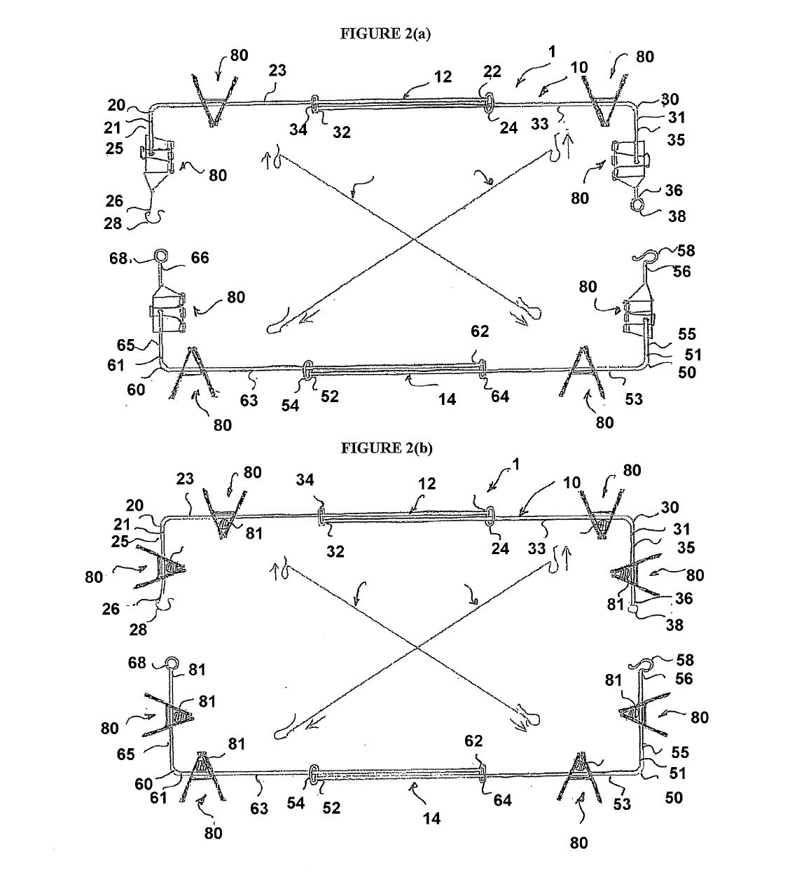

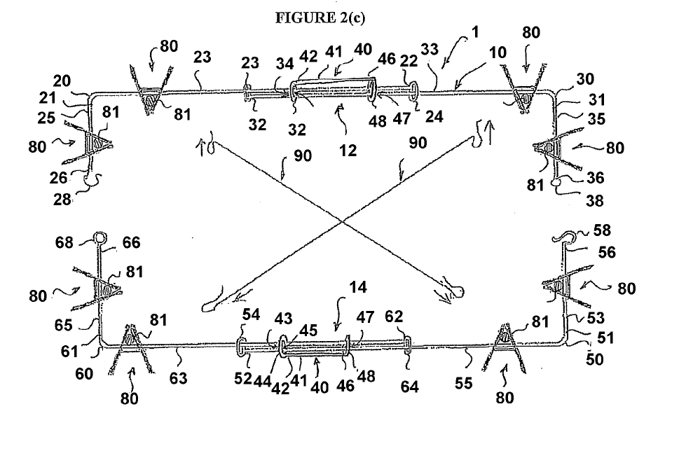

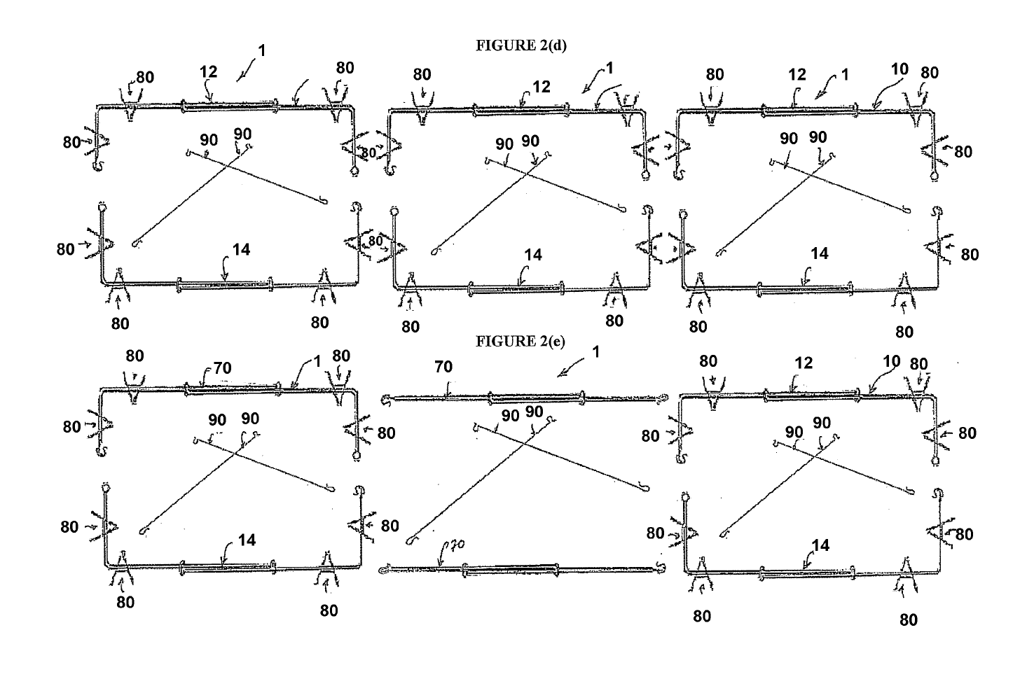

In another embodiment shown in FIGS. 2(a)-2(e), plant support system 1 may have a modular construction including a substantially rectangular frame 10 adapted for supporting row crops formed from two or more removably connected frame members 12, 14. Each frame member 12, 14 is constructed from a first wire 20, 60 and a second wire 30, 50 that are adjustably interconnected to change the size and dimensions of frame 10. Furthermore, plant support system 1 can include two or more interconnected frames 10 arranged in a row.

As shown in FIGS. 2(a)-2(b), frame 10 has a rectangular structure formed from two substantially U shaped frame members 12, 14 that are removably attached to one another. First and second frame members 12, 14, each constructed from two substantially L shaped interconnected wires 20, 30 and 50, 60, have the same size, structure and configuration. Therefore the following description of second frame member 14 is also applicable to second frame member 12. First and second substantially L shaped wires 50, 60 of second frame member 14 each have a first section 53, 63 perpendicularly oriented with respect to a second section 55, 65. As shown, second frame member second sections 55, 65 have a fixed length forming the sides of U shaped frame 10. Second frame member first and second wire first ends 52, 62 of first section 53, 63 are adjustably interconnected by loop fasteners 54, 64, which prevent separation of first and second wires 50, 60. Loop fasteners 54, 64 are may have the same structure, configuration and may be oriented in the same manner as the embodiment shown in FIGS. 1(a)-1(c). The adjustable first ends 52, 62 overlap, forming the middle region of U shaped first frame member 12. A mating fastener 58, 68, having the same structure, configuration and oriented in the same manner as the embodiment shown in FIGS. 1(a)-1(c), is formed on each of opposing second ends 56, 66 of second section 55, 56. Preferably, first and second frame member 12, 14 each has a pair of male and female mating fasteners 58, 68 enabling first and second frame members 12, 14 to be removably attached to one another. In the embodiment of FIG. 2(a)-2(b), second frame member 14 has a hook fastener 58 and a loop fastener 68 that are removably connected to a loop fastener 28 and hook fastener 38 of first frame member 12, respectively, forming a rectangular frame 10.

In an exemplary embodiment, frame 10 may be retracted and expanded such that first sections 23, 33 of first frame member 12 completely overlap, partially overlap or are only connected at first and second wire first ends 22, 32. Corresponding first sections 53, 63 of frame member 14 may also be similarly adjusted and positioned. In one embodiment, each of first frame member first sections 23, 33 may have a length of about 6 in to about 12 in; second frame member first sections 63, 53 may have the same length such that the width of frame 10 formed by these sections is about 12 in to about 24 in. Each of frame member second sections 25, 65 has a length of about 24 in to about 48; second frame member second sections 35, 55 similarly has the same length such that the opposing sides of frame 10 formed by second sections 25, 65 and 35, 55 of first and second frame members 12, 14 have a length of about 48 in to about 96 in.

As shown in FIG. 2(c), an optional stabilizer 40 may be coupled to and support each of first frame member wires 20, 30 and second frame member wires 50, 60 in a substantially rigid manner. In one embodiment, stabilizer 40 may have substantially the same structure and configuration as described in FIG. 1(c) with the exception that the wire body 41 of stabilizer 40 has a linear elongated configuration.

A plurality of stake fasteners 80 may have the same structure, configuration and may also be coupled to frame 10 in the same manner as described above with respect to the embodiment of FIGS. 1(a)-1(j). Preferably each frame member 12, 14 of FIGS. 2(a)-2(c) can have one or more, two or more, three or more or four or more stake fasteners 80. In one embodiment, one or two stake fasteners 80 may be arranged proximate to the corners of frame 10. As shown in FIGS. 2(a)-2(c), each one of first section 23, 33, 53, 63 and second section 25, 35, 55, 65 has a stake fastener 80. Preferably, at least two stake fasteners 80 are positioned on opposite sides of each corner of rectangular frame 10. In an alternative embodiment, stake fasteners 80 may be equidistantly positioned along the body of frame 10.

One or more support members 90 having the same size, structure, configuration and arrangement as discussed above with respect to the embodiment of FIGS. 1(h)-1(j), may be positioned across rectangular frame 10 to secure one or more plants. In an exemplary embodiment, support members 90 may have a length substantially equal to about the length, width or diagonal length of rectangular frame 10. In one embodiment, plant support system 1 may include two or more support members 90 having different lengths to accommodate the changing dimensions of rectangular frame 10 as it is adjusted to different sizes. For example, plant support system 1 may include a plurality of support members some having a length of about 6 in to about 18 in, preferably about 12 in to about 18. Other support members may have a length of about 24 in to about 96 in, and still others may have a length of about 50 in to about 99 in.

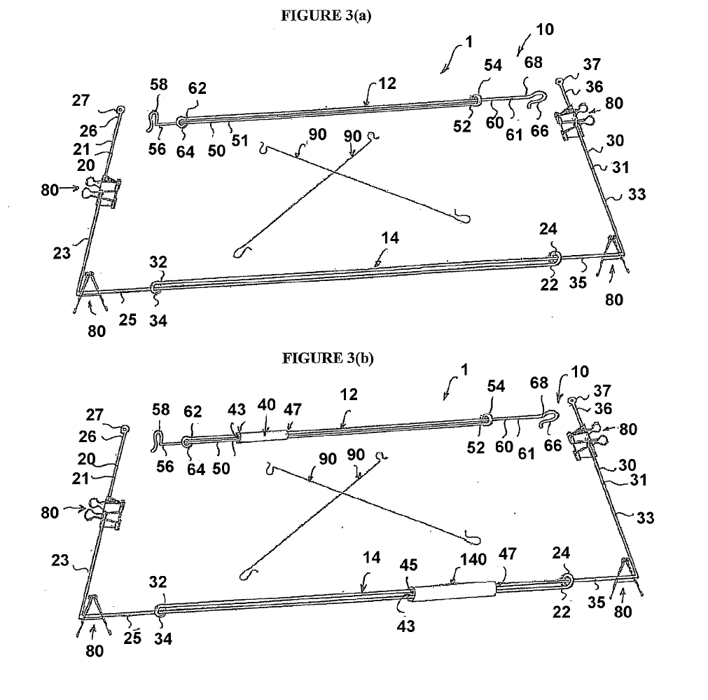

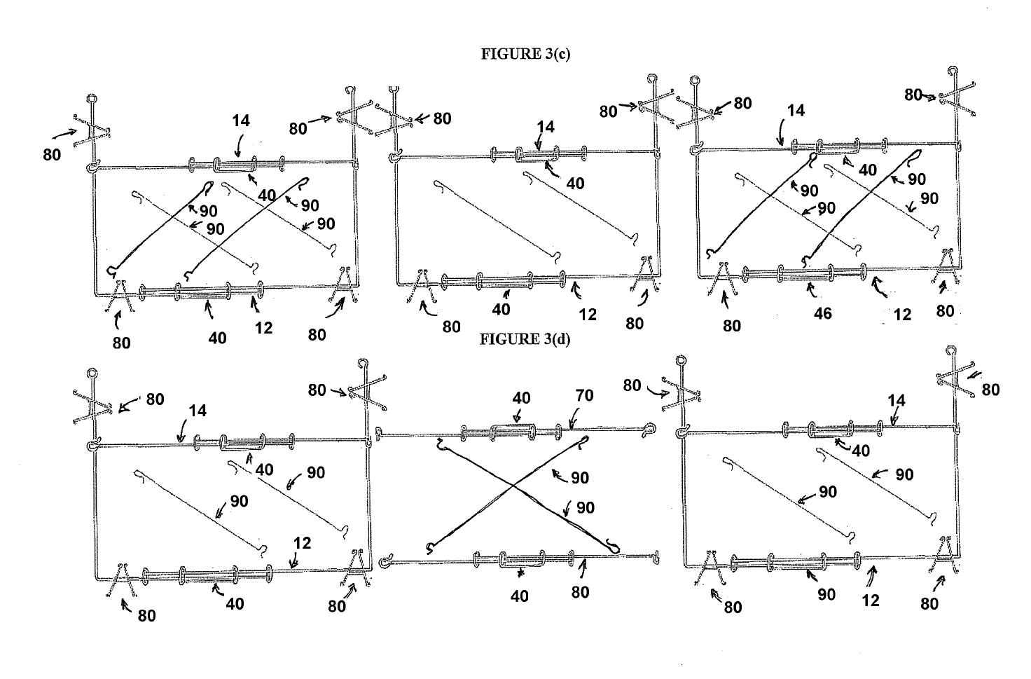

In another embodiment shown in FIGS. 3(a)-3(d), plant support system 1 may have a modular construction similar to the embodiment of FIGS. 2(a)-2(e). As shown in FIG. 3(a), frame 10 has a substantially rectangular configuration adapted for supporting a row of plants. Frame 10 is formed from a substantially U shaped first frame member 12 and a substantially linear second frame member 14 removably attached thereto. With the exception of second ends 26, 36, first frame member 12, constructed from two interconnected and substantially L shaped wires 20, 30, has the same structure and configuration as the first frame member 12 described in FIGS. 2(a)-2(e). In this embodiment, second ends 26, 36 of first frame member wires 20, 30 each have a terminal structure 27, 37 that prevents stake fasteners 80 and/or removably coupled linear second frame member 14 from being sliding off of second ends 26, 36. Exemplary terminal structures 27, 37 may include a rounded protrusion, a bar, plate or other obstruction that is attached and preferably oriented orthogonal to second ends 26, 36.

A second linear frame member 14 is constructed from a linear first wire 50 and linear second wire 60 that are adjustably interconnected. First ends 52, 62 of first and second wires 50, 60 are adjustably interconnected by loop fasteners 54, 64 having the same structure, configuration and may be oriented in the same manner as that described in FIGS. 2(a)-2(e), which secure and prevent the separation of first and second wires 50, 60. Opposing second ends 56, 66 formed on second frame member wire second ends 52, 62 terminate in hook fasteners 54, 64 adapted to be removably coupled to first frame member 12. Preferably, hook fasteners 54, 56 have the same configuration as the hook fastener 54 of the embodiment of FIGS. 1(a)-1(j). In an exemplary embodiment, hook fasteners 54, 64 have a pinched neck adapted for securing wire of first frame member 12 within an aperture of hook fastener 54, 64. The opening defined by the pinched neck is preferably substantially equal to or smaller than the diameter of a first or second wire 20, 30 of first frame member 12. Hook fasteners 54, 56 may be substantially perpendicular to or parallel to first end 52 and the longitudinal axis of wire body 51. In one embodiment, first wire hook fastener 54 may be oriented substantially parallel to first end 52 and the longitudinal axis of wire body 51 while second wire hook fastener 64 is oriented substantially perpendicular to first end 62 and the longitudinal axis of wire body 61.

In an exemplary embodiment, frame 10 may be retracted and expanded such that first sections 23, 33 of first frame member 12 completely overlap, partially overlap or are only connected at first and second wire first ends 22, 32. In the embodiment shown in FIGS. 2(a)-2(b), the area covered by frame 10 is preferably about 576 in to about 2,304 in when frame 10 is fully expanded and about 144 in to about 576 in when fully retracted. In the embodiment shown in FIGS. 3(a)-3(b), the area covered by frame 10 is preferably about 228 in to about 1,152 in when fully expanded; this area may be incrementally reduced as desired by sliding linear frame member 14 towards first sections 25, 35 of first frame member 12.

One or more stabilizing members 40 may be coupled to and surround first and second wires 20, 30 of the U shaped first frame member 12, and one or more stabilizing members 40 may be coupled to and surround first and second wires 50, 60 of the linear second frame member 14 to support and substantially align first frame member wires 20, 30 and second frame member wires 50, 60. Stabilizer 40 may have the same structure, configuration and arrangement relative to wires 20, 30, and 50, 60 as any of the aforementioned stabilizers 40.

In the embodiment shown in FIG. 3(b), stabilizer 40 may be configured as a cylindrical tube slidably adjustable along and having an elongated passageway 43 for receiving first frame member wires 20, 30 or second frame member wires 50, 60. Passageway 43 is configured as an elongated channel defined by first and second openings 45, 47 located on opposite sides of stabilizer 40. In one embodiment, the cylindrical tube is sized to tightly and securely retains first and second wires 20, 30, such that the diameter of the tube is only slightly larger than the combined diameters of first member wires 20, 30 or second member wires 50, 60. This embodiment of stabilizer 40 may also be used with the embodiment of frame 10 shown in FIGS. 1(a)-1(j), preferably wherein elongated cylindrical tube is curved so as to conform with the curvature of wires 20, 30.

A plurality of stake fasteners 80 may have the same structure, configuration and may be coupled to first frame member 12 in the same manner as that described with respect to the embodiment of FIGS. 2(a)-2(e). Preferably, four stake fasteners 80 may be positioned along first frame 12 such that a stake fastener 80 is coupled to each of first section 23, 33 and second sections 25, 35. In one embodiment, stake fasteners 80 may be positioned substantially equidistantly along first frame member 12. In another embodiment, as shown in FIGS. 3(a)-3(b), two stake fasteners 80 are located proximal to the terminal ends 27, 37 and two stake fasteners 80 are position proximal to the corners of first frame member 12.

One or more support members 90 having the same structure, configuration and arrangement relative to frame 10 as discussed above with respect to the embodiment of FIGS. 2(a)-2(e), may be positioned across rectangular frame 10 to secure one or more plants.

As shown in FIGS. 2(d) and 3(c), two or more plant support systems 1 may be arranged in a row to provide further support to one or more crops planted in a row. Alternatively, as shown in FIGS. 2(e) and 3(d), plant support system 1 may include tow or more frames 10 arranged to form an interconnected structure configured to structurally support a row of plants. Two frames or more frames 10 may be spaced apart from one another and interconnected using one or more extension members 70 and/or one or more support members 90.

Extension members 70 may have any suitable configuration for connecting two or more frames 10 and providing structural support to a plant positioned between two adjacent frames 10. In one embodiment, extension member 70 has the same structure and configuration as linear second frame member 14, as described in the embodiment of FIGS. 3(a)-3(d), and is adapted to be removably attached to the frames 10 of two adjoining plant support systems 1. The hook fasteners 74, 78 of extension member 70 may be removably attach to the frame members 12, 14 of adjoining frames 10. Preferably, a pair of extension members 70 is positioned between two adjoining frames 10 linearly aligning the sides of the two frames 10. Extension members 70 may be positioned between a series of frames 10 arranged in a row, such that frames 10 and extension members 70 form an elongated rectangular plant support system composed of a series of rectangular plant support structures.

Plant support system 1 of the present invention provides a number of advantages over conventional plant support systems. By virtue of its ability to adjust the height of frame 10 relative to stakes 81 and the size of frame 10, plant support system 1 can accommodate plants of varying heights and widths, accommodating the plant throughout its various developmental stages. The interlocking wires 20, 30, 50, 60 of first and second frame members 12, 14 provide a means to easily, rapidly and effectively adjust the size of frame 10. Additionally, the separable nature of frame 10 enables it to be easily positioned around large, fully grown plants. Another advantage of plant support system 1 is the ability for stake fastener 80 to be used with and removably coupled to any conventional stake. Furthermore, one or more extension members 70 may be coupled to two adjoining plant support system 1 to form a modular row crop support system. By virtue of being removably coupled to frame 10, support members 90 may be reused and rearranged as desired to provide customized support to a plant as it grows. While plant support system 1 may have a wide variety of applications, it is particularly well suited to providing structural support for one or more trees, shrubs, ornamental flowering plants, and crop plants of varying sizes.

The invention is further directed to a method for using the plant support system 1 to support one or more plants. The method involves positioning one or more stakes 81 around one or more plants, adjusting frame 10 to accommodate the one or more plants, attaching the frame 10 at a desired height to one or more stakes 81, and placing one or more support members across frame 10 to brace one or more plants against frame 10. In an exemplary embodiment, the method may further involve the step of interconnecting two or more plant support systems 1 to support a row of plants. After use, plant support system 1 may be disassembled and stored in a compact configuration for subsequent use.

One or more stakes 81, preferably about two to about eight, more preferably, about two to about six and most preferably, about two to about four stakes 81, are positioned around one or more plants. Stakes 81 may be inserted into the soil and arranged such that they are spaced apart from the supported plant or engage a part of the plant, such as the foliage, branches, truck or combination thereof. In one embodiment, a plurality of stakes 81 may be equidistantly positioned around the one or more plants. In another embodiment, stakes 81 may be anchored in the ground at the corners of a plant or a row of plants.

The dimensions of frame 10, such as its length and/or width, may be adjusted as desired to conform to the placement of one or more stakes 81 and to surround one or more plants. Frame 10 may be sized and positioned to encircle a plant, wherein frame 10 is either spaced apart from or directly engages a portion of the plant. For example in one embodiment, frame 10 may engage a perimeter of the plant body such that frame 10 contacts and/or presses against one or more parts of the plant, such as the foliage, branches, truck or combinations thereof.

Frame 10 may be positioned around the plant by slipping the unified frame 10 over the top of the plant and fastening it to stakes 81. Alternatively, two or more wires 20, 30 of or two or more frame members 12, 14 of frame 10 may be separated, to facilitate the placement of frame 10 around one or more plants. By virtue of having one or more separable wires and/or two or more separable frame members 12, 14, a user can easily and directly position frame 10 around the circumference of wide and/or tall plants, allowing plant support system 1 to be installed even after a plant is fully grown.

When using the plant support system of FIGS. 1(a)-1(j), first and second wire mating fasteners 28, 38 may be uncoupled to facilitate the placement of frame 10 around one or more plants. Upon encircling the plant, mating fasteners 28, 38 may be attached to form an enclosed annular frame 10. Frame 10 may be expanded by sliding first wire 20 and second wire 30 in opposite directions so that first and second wire first ends 22, 32 are drawn towards one another. To decrease the width of frame 10, first wire first end 22 is drawn away from second wire first end 32, thereby increasing the overlapping region of first and second wires 20, 30. Upon achieving a desired frame size, stabilizer 40 may be positioned between first ends 22, 32, preferably at a central region between first ends 22, 32, to support and substantially align first and second wires 20, 30 with the longitudinal axis of first and second wires 21, 31. Optionally, stabilizer 40 may also operate as a locking mechanism, wherein stabilizer 40 may be slidably positioned to a region of first and second wires 20, 30 that frictionally engages stabilizer 40. Preferably, stabilizer 40 is slidably positioned proximal to first wire first end 22 or second wire first end 32 to fixedly secure the position of wires 20, 30. Upon sliding stabilizer 40 away from first ends 22, 32, first and second wires 20, 30 may be further adjusted as desired.

When using the rectangular frame 10 shown in FIGS. 2(a)-2(e), one or both pairs of corresponding wire second ends 26, 66 and 36, 56 of U shaped first and second frame members 12, 14 may be detached to facilitate placement of frame 10 around one or more plants. The plant support system shown in FIGS. 2(a)-2(e) may be particularly well suited to supporting a row of crops. Subsequently, first wire second ends 26, 66 are attached to second wire second ends 36, 56 after surrounding the plant to be supported. The size of rectangular frame 10 may be modified by adjusting the degree to which the first sections 23, 33 and first ends 22, 32 of the L shaped wires 20, 30 are overlapped and by correspondingly adjusting the degree to which the first sections 53, 63 and first ends 52, 62 of the L shaped wires 50, 60 are overlapped. The dimensions of first frame members 12 therefore may be adjusted by respectively sliding first ends 22, 32 towards and away from one another. The dimensions of second frame 14 may also be similarly adjusted. Slidably interconnected first and second wires 20, 30 and 50, 60 therefore make it possible to adjust the length of two opposing sides of rectangular frame 10. Once the desired size of frame 10 is achieved, stabilizer 40 may be positioned to support and align first wires 20, 50 and second wires 30, 60 with the longitudinal axis of first wires 20, 50 and second wires 30, 60 and/or fixedly secure first and second wires 20, 30 and 50, 60 relative to one another in the same manner as discussed above.

When using the rectangular frame 10 shown in FIGS. 3(a)-3(d), U shaped first frame member 12 may be detached from second frame member 14 to facilitate placement of frame 10 around one or more plants. The dimensions of frame 10 may be modified by slidably extending and retracting first portion 23, 33 and first ends 22, 32 of first and second L shaped wires 20, 30 relative to one another and by correspondingly extending and retracting the first ends 22, 32 of linear first and second wires 50, 60 of the second linear frame member 14 relative to one another. First wires 20, 50 and second wires 30, 60 may be stabilized, aligned and optionally fixedly positioned relative to one another in the same manner as discussed above with respect to the embodiment of FIGS. 2(a)-2(e).

A user may subsequently attach frame 10 to one or more stakes 81 using stake fasteners 80. Stake fasteners 80, slidably coupled to frame 10, are position along frame 10 at locations corresponding to the position of stakes 81. When stake fastener 80 is configured as a pinch clamp, a user may squeeze distal ends of handle 88 towards one another forcing the pinched ends of spring biased walls 86 to open providing an entrance to the internal cavity 81 of stake fastener 80. A stake 81 can then be inserted through the ends of walls 86 and fixedly secured within cavity 81. Upon releasing handles 88, the inner surface of walls 86 and base 84 compress against and clamp around stake 81 such that is held in a fixed position along stake 81. Stake fasteners 80 may thereby be used to fixedly secure frame 10 at a specific location and at a desired height along stake 81. As the plant grows, frame 10 may be vertically adjusted as desired. Upon applying a compressive force to the distal end of handles 88, stake fastener 80 may be either vertically slid along stake 81 or entirely uncoupled from stake 81 and subsequently reattached upon releasing the pressure from handles 88. Additionally, stakes 81 may also be removed from the ground and repositioned as the plant expands in width. In this instance, stake fasteners 80 may either remain coupled to stakes 81 or may be detached from and subsequently reattached to the repositioned stakes 81.

The plant may be braced against one or more support members 90 removably coupled to frame 10. Support members 90 may be positioned against or pushed through the foliage or branches of the plant to support the plant. Preferably, one support member 90 may be positioned proximate to the trunk of the plant. In one embodiment, at least two support members coupled to frame 10 are used to support one or more plants. The support members may cross over one another, preferably support members 90 are oriented perpendicular to one another or otherwise form an X shaped pattern, as shown in FIGS. 1(a), 2(a) and 3(a), wherein the plant is positioned between the two support members. This orientation braces the plant material, preventing it from slipping to one side and supports the plant in a natural upright position. In another embodiment, at least three support members enclosing the stem of the plant in a triangular configuration may be employed. Support members 90 may also be arranged in an overlapping diagonal cross-hatching pattern relative to frame 10, as shown in FIG. 3(c).

Each support member 90 may be fastened to two portions of frame 90 using hook ends 94, 98. When using the support member 90 shown in FIG. 1(h), a user places first hook end 94 oriented parallel to the body of support member 91 over a first wire region of frame 10 and pulls support member 90 until it hooks and snaps over the narrow neck of hook end 94. Upon pushing against an upper surface of support member 90, the perpendicular hook end 98 is subsequently hooked and snapped over another wire portion of frame 10. When using the support member 90 shown in FIG. 1(i), support member 90 may be coupled to frame 90 by pushing against an upper surface of support member 90 until each perpendicular hook end 94, 98 is snapped over a wire region of frame 10. When using the support member 90 shown in FIG. 1(j), a user places first hook end 94 oriented parallel to the body of support member 91 over a first wire region of frame 10 and inserts another wire region of frame 10 within the second parallel hook end 98.

As shown in FIGS. 2(d) and 3(c), a user may align two or more plant support systems 1 to support a row of plants. In this embodiment, two or more frames 10 may be arranged in a row, closely positioned proximal to one another. Each frame 10 may surround and support one or more plants of the row crop.

In another embodiment shown in FIGS. 2(e) and 3(d), plant support system 1 includes two or more frames that may be interconnected to form a modular, elongated support structure. In this embodiment, two or more frames 10 may be positioned around two separate plants or sets of plants that are spaced apart from one another and arranged in a row. The two or more frames 10 are arranged so that they are spaced apart from one another and aligned such that one side of each frame 10 is oriented parallel to one another. Two extension members 70 are removably connected to the two sides of spaced apart frames 10, surrounding one or a set of plants located between two frames 10. Support members 90 may be coupled to extension members 70 and/or frames 10 in the same manner as that discussed above to support plants positioned between two frames 10. Extension members 70 in combination with two opposing sides of frames 10 therefore form an integrated plant support system.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A plant support system comprising:
a frame for surrounding a plant, wherein the frame comprises:
a first frame member, wherein the first frame member comprises:
two wires slidably positioned relative to one another to adjust the frame size, wherein each wire comprises a first end and wherein the first ends of the two wires are interconnected relative to one another such that the first ends slidably overlap one another; and
a fastener for coupling the frame to a stake.

2. The system of claim 1, wherein the first ends overlap and are spaced apart from one another.

3. The system of claim 2, wherein the frame further comprises a loop formed on each of the first ends.

4. The system of claim 3, wherein one of the loops is substantially perpendicular to an adjoining first end.

5. The system of claim 3, wherein one of the loops is oriented at an angle of about 45° to about 60° with respect to an adjoining first end.

6. The system of claim 1, wherein each of the two wires further comprises a second end, and wherein the two wires are removably attached to one another at the second end.

7. The system of claim 6, wherein the two wires are removably connected by a hook and loop.

8. The system of claim 1, further comprising a stabilizer that receives and is coupled to the two wires, wherein the stabilizer supports and substantially aligns the first ends.

9. The system of claim 8, wherein the stabilizer comprises an elongated body comprising a passageway for receiving the two wires.

10. The system of claim 9, wherein the passageway is defined by two openings positioned on opposite ends of the body.

11. The system of claim 10, wherein the stabilizer has a substantially tubular body.

12. The system of claim 10, wherein the stabilizer has an elongated wire body comprising two loops formed on opposite ends of the wire body.

13. The system of claim 1, wherein the stabilizer fixedly secures the position of the two wires relative to one another.

14. The system of claim 1, wherein the system further comprises a first support member comprising two hook ends, and wherein the first support member is removably coupled to the frame such that it may be removably attached to and positioned across the frame.

15. The system of claim 1, wherein at least one of the two hook ends is substantially perpendicular to the longitudinal axis of the first support member.

16. The system of claim 1, wherein at least one of the two hook ends is substantially parallel to the longitudinal axis of the first support member.

17. The system of claim 14, wherein the system further comprises a second support member removably attached to and positioned across the frame, wherein the second support member intersects the first support member.

18. The system of claim 1, wherein the fastener is a pinch clamp permanently coupled to the frame and capable of being removably attached to an anchoring stake.

19. The system of claim 1, wherein the frame further comprises a second frame member removably attached to the first frame member, wherein the second frame member comprises two wires slidably positioned relative to one another, wherein each wire comprises a first end and wherein the first ends of the two wires are interconnected relative to one another such that the first ends slidably overlap one another.

20. The system of claim 19, wherein each of the two wires of the first frame member has a substantially L shaped configuration and wherein the two wires are interconnected so as to form a substantially U shaped first frame member.

21. The system of claim 20, wherein each of the two wires of the second frame member has a substantially L shaped configuration and wherein the two wires are interconnected so as to form a substantially U shaped second frame member.

22. The system of claim 20, wherein each of the two wires of the second frame member has a substantially linear configuration.

23. The system of claim 1, wherein the frame has a substantially circular, elliptical or rectangular configuration.

24. The system of claim 1, further comprising a second frame, wherein the first and second frames are connected by an extension member.

25. The system of claim 1, wherein the extension member comprises two linear wires slidably positioned relative to one another, wherein each linear wire comprises a first end and wherein the first ends of the two wires are interconnected relative to one another such that the first ends slidably overlap one another.

26. A plant support system for supporting a plant, wherein the system comprises:
a frame for surrounding the a plant, wherein the frame comprises two interconnected wires slidably coupled relative to one another to adjust the frame size; and
two pinch clamps permanently and adjustably coupled to the frame, wherein at least one of the wires of the frame is slidably inserted through the pinch clamp.

27. The system of claim 26, wherein each of the two clamps are spring biased in a closed configuration for securing an anchoring stake.

28. The system of claim 27, wherein each of the two pinch clamps has a substantially triangular body comprising a base connected to two side walls forming a retractable, clamping mouth.

29. The system of claim 28, wherein each of the two pinch clamps comprises two handles attached to the two side walls that open the pinch clamp when the handles are drawn towards one another.

30. The system of claim 29, wherein the frame is inserted through the side walls of each of the two pinch clamps.

31. The system of claim 30, wherein the wire frame is inserted through a cavity of each of the pinch clamp that is intended to receive an anchoring stake.

32. The system of claim 28, wherein the base comprises a protrusion and wherein a portion of the frame is received within the protrusion.

33. A plant support system for supporting a plant, wherein the system comprises:
a frame for surrounding the plant, wherein the frame comprises a first frame member comprising two wires slidably coupled relative to one another to adjust the frame size; and
two fasteners capable of being removably coupled to a stake, wherein the fastener is permanently and adjustably attached to the frame, and
a support member removably attached to and positioned across the frame that braces the plant relative to the frame.

34. The system of claim 33, further comprising a second frame member removably attached to the first frame member, wherein the second frame member comprises two wires slidably coupled relative to one another.

35. The system of claim 18, wherein the two fasteners are slidably positioned along the frame.

36. The system of claim 1, wherein the support member comprises two hook ends adapted to removably attach to a portion of the frame.

37. The system of claim 36, wherein at least one of the two hook ends comprises a pinch neck region for securing the support member to the frame.
